(19) United States
(12) Patent Application Publication
(10) Pub. No.: US 2005/0215755 A1
(43) Pub. Date: Sep. 29, 2005

(54) Poly(2-vinylpyridine)-b-poly(n-hexylisocyanate) amphiphilic coil-rod block copolymer and polymerization method thereof

(76) Inventors: Jae-Suk Lee, Buk-gu (KR); Sang-Ho Han, Buk-gu (KR); Hyeong-Jin Kim, Buk-gu (KR); Yeong-Deuk Shin, Buk-gu (KR); Shashahar Samal, Buk-gu (KR)

Correspondence Address: FROMMER LAWRENCE & HAUG, 745 FIFTH AVENUE- 10TH FL., NEW YORK, NY, 10151, US

(21) Appl. No.: 10/993,717

(22) Filed: Nov. 19, 2004

(30) Foreign Application Priority Data
Mar. 29, 2004 (KR) 10-2004-0021260

(51) Int. Cl. C08G 63/78

(52) U.S. Cl. 528/280

(57) ABSTRACT

The present invention relates to a poly(2-vinylpyridine)-b-poly(n-hexylisocyanate) amphiphilic coil-rod block copolymer and a polymerization method thereof, more particularly to a poly(2-vinylpyridine)-b-poly(n-hexylisocyanate) amphiphilic coil-rod block copolymer polymerized by a process comprising synthesizing poly(2-vinylpyridine) having a narrow molecular weight distribution by living polymerization using potassium diphenylmethane (K-DPM) as initiator, adding sodium tetraphenylborate (NaBPh₄) to replace the counter cation with a sodium ion (Na⁺) and adding n-hexylisocyanate and performing polymerization and a polymerization method thereof. According to the present invention, it is possible to control the molecular weight and the structure of each block of the copolymer. Therefore, coil-rod type amphiphilic block copolymers having a variety of structures can be obtained. The resultant block copolymer is a useful optical polymer material.

### BACKGROUND OF THE INVENTION

1. Field of the Invention

The present invention relates to a poly(2-vinylpyridine)-b-poly(n-hexylisocyanate) amphiphilic coil-rod block copolymer and a polymerization method thereof, more particularly to a poly(2-vinylpyridine)-b-poly(n-hexylisocyanate) amphiphilic coil-rod block copolymer polymerized by a process comprising synthesizing poly(2-vinylpyridine) having a narrow molecular weight distribution by living polymerization using potassium diphenylmethane (K-DPM) as initiator, adding sodium tetraphenylborate (NaBPh₄) to replace the counter cation with a sodium ion (Na⁺) and adding n-hexylisocyanate and performing polymerization and a polymerization method thereof.

2. Description of Related Art

Conventionally, anion polymerization using an alkyllithium initiator has been predominant as a method of polymerizing poly(2-vinylpyridine). However, if the anion polymerization is performed in a nonpolar solvent, the alkyllithium initiator attacks the pyridine ring, so that it is difficult to control the molecular weight. As a result, the molecular weight distribution becomes broad and the yield of polymerization becomes low (Nakamura, N.; Yoshino, A.; Takahashi, K. Bull. Chem. Soc. Jpn. 1994, 67, 26.; Clegg, W.; Dunbar, L.; Horsburgh, L.; Mulvey, R. E. Angew. Chem., Int. Ed. Engl. 1996, 35, 753.). And, if the anion polymerization is performed in a polar solvent such as tetrahydrofuran (THF), it is known that such a ligand as lithium chloride (LiCl) is required to obtain a quantitative yield. However, lithium chloride is less soluble in the solvent and is limited in use only for an alkyllithium initiator.

An amphiphilic coil-rod block copolymer has been gaining much attention as an optical precision polymer material because of such properties as phase separation, self-assembling, etc. (Lee, M.-S.; Cho, B.-K.; Zin, W.-C. Chem. Rev. 2001, 101, 3869 Forster, S.; Antonietti, M. Adv. Mater. 1998, 10, 195 Thomas, E. L.; Chen, J. T.; O'Rourke, M. J. E. Macromol. Symp. 1997, 117, 241; Ishizu, K. Prog. Polym. Sci. 1998, 23, 1383 Forster, S.; Plantenberg, T. Angew. Chem. Int. Ed. 2002, 41, 688; Klok, H.-A.; Lecommandoux, S. Adv. Mater. 2001, 13, 1217.). Conventionally, amphiphilic block copolymer materials having a coil-coil structure have been developed. Recently, polystyrene-b-polyisocyanate and polyisoprene-b-polyisocyanate having a rod structure have been developed (Ahn, J.-H.; Lee, J.-S. Macromol. Rapid Commun. 2003, 24, 571; Chen, J. T.; Thomas, E. L.; Ober, C. K.; Mao, G.-P. Science, 1996, 273, 343 Chen, J. T.; Thomas, E. L.; Ober, C. K.; Hwang, S. S. Macromolecules 1995, 28, 1688). However, for these block copolymers, polymerization of polyisocyanate is difficult. Thus, materials having high block ratio of styrene or isoprene, which have relatively stable polymerization mechanism, have been more commonly used.

### SUMMARY OF THE INVENTION

The present inventors tried to synthesize a new amphiphilic coil-rod block copolymer comprising a coil type block having a hydrophilic functional group and a lipophilic rod type isocyanate block.

In doing so, they developed a living polymerization technique of 2-vinylpyridine using potassium diphenylmethane (K-DPM) as initiator. With the living polymerization technique, it became possible to synthesize poly(2-vinylpyridine) having a narrow molecular weight distribution at a quantitative yield. Then, sodium tetraphenylborate (NaBPh₄) was added to the resulting poly(2-vinylpyridine) to replace the counter cation with a sodium ion (Na⁺). Then, copolymerization was performed by adding n-hexylisocyanate to obtain an amphiphilic coil-rod type poly(2-vinylpyridine)-b-poly(n-hexylisocyanate) having a block structure with controlled molecular weight.

Accordingly, it is an aspect of the present invention to provide an amphiphilic coil-rod type block copolymer of 2-vinylpyridine and n-hexylisocyanate.

It is another aspect of the present invention to provide a method of polymerizing the block copolymer.

### BRIEF DESCRIPTION OF THE DRAWINGS

FIG. 1 is a schematic diagram illustrating the anion polymerization apparatus used to synthesize the block copolymer of the present invention.

FIG. 2 is a schematic diagram illustrating the anion polymerization apparatus used to synthesize homopolymers according to Examples 1 and 2.

FIG. 3 is a graph showing the molecular weight and the molecular weight distribution of poly(2-vinylpyridine) versus the molar ratio of 2-vinylpyridine and initiator.

FIG. 4 shows the ¹H NMR spectrums of the 2-vinylpyridine monomer and the poly(2-vinylpyridine) homopolymer.

FIG. 5 shows the ¹H NMR spectrums of the poly(2-vinylpyridine)-b-poly(n-hexylisocyanate) block copolymer.

FIG. 6 shows the gel permeation chromatography result of the poly(2-vinylpyridine) homopolymer and the poly(2-vinylpyridine)-b-poly(n-hexylisocyanate) block copolymer.

FIG. 7 shows the AFM of the poly(2-vinylpyridine)-b-poly(n-hexylisocyanate) block copolymer.

### DETAILED DESCRIPTION OF THE PREFERRED EMBODIMENTS

The present invention relates to an amphiphilic coil-rod block copolymer represented by Formula 1 below, which comprises a coil type poly(2-vinylpyridine) block having a hydrophilic and a rod type poly(n-hexylisocyanate) block having a lipophilic group, and a polymerization method thereof: 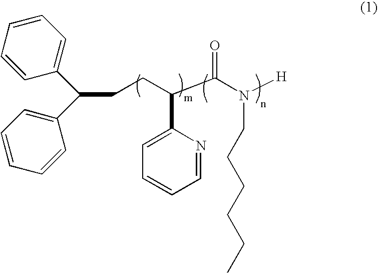
wherein m is a degree of polymerization of the poly(2-vinylpyridine) block; n is a degree of polymerization of the poly(n-hexylisocyanate); and f₂ᵥₚ, the proportion of the poly(2-vinylpyridine) block in the block copolymer, satisfies 0<f₂ᵥₚ<1.

Hereunder is given a more detailed description of the present invention.

The method of preparing the block copolymer represented by Formula 1 of the present invention comprises the steps of:
1) synthesizing a poly(2-vinylpyridine) block by living polymerization using potassium diphenylmethane (KCHPh₂) as initiator;
2) replacing the potassium counter cation of the poly(2-vinylpyridine) by with a sodium ion by adding sodium tetraphenylborate (NaBPh₄); and
3) adding n-hexylisocyanate and performing polymerization to obtain a poly(n-hexylisocyanate) block.

All the polymerization reactions of the present invention are performed under a high vacuum (10⁻⁶ torr), low temperature (−78 to −100° C.) condition, using a polymerization apparatus comprising ampoules containing an initiator, a monomer, an additive, a reaction terminator, etc. (see FIG. 1). Polymerization is performed by the typical anion polymerization process. For the polymerization solvent, the commonly used organic solvent for anion polymerization, typically tetrahydrofuran, is used.

Each step of the polymerization method will be described in more detail below.

In the first step, a poly(2-vinylpyridine) block is synthesized by living polymerization by the reaction shown in Scheme 1 below.

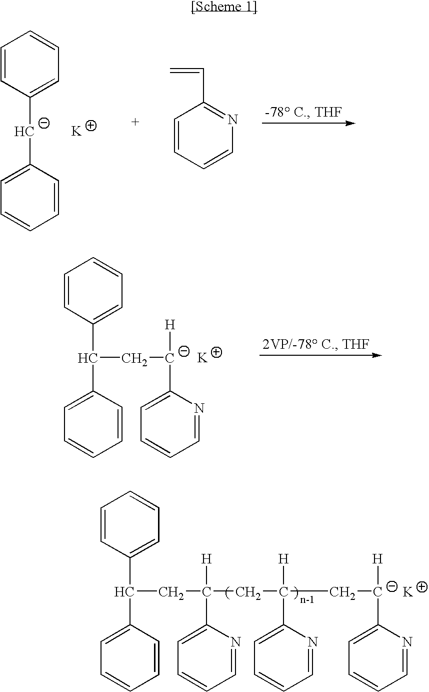

The block copolymerization apparatus illustrated in FIG. 1 is used. First, an ampoule containing an initiator is broken by an internal magnet, so that the initiator is fed to a reaction flask set at −90 to −40° C. After the initiator solution reaches the polymerization temperature, it is fed to a flask containing 2-vinylpyridine. Then, polymerization is performed for about 20 to 40 minutes to synthesize a poly(2-vinylpyridine) homopolymer.

In the general anion polymerization of poly(2-vinylpyridine) using alkyllithium as initiator, it is difficult to control the molecular weight. However, in the present invention, living polymerization using potassium diphenylmethane (KCHPh₂) as initiator is employed, so that it is possible to control the molecular weight of the poly(2-vinylpyridine) homopolymer more efficiently. The resulting poly(2-vinylpyridine) has a molecular weight distribution (M_{w}/Mₙ) ranging from about 1.00 to 1.09.

In the second step, the counter cation of the poly(2-vinylpyridine) is replaced as shown in Scheme 2 below.

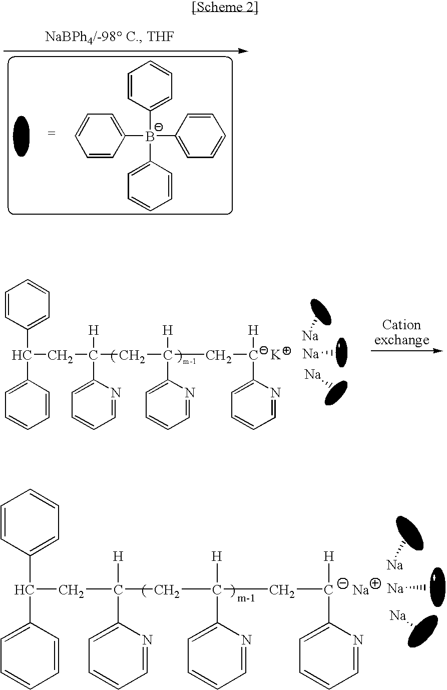

In the cation exchange reaction of Scheme 2, sodium tetraphenylborate (NaBPh₄) is used as additive, so that the counter cation is replaced with a sodium ion (Na⁺), which is suitable for the polymerization of n-hexylisocyanate. The cation exchange reaction is performed in the temperature range of −100 to −60° C.

In the third step, a poly(n-hexylisocyanate) block is polymerized according to Scheme 3 below to prepare the block copolymer of the present invention.

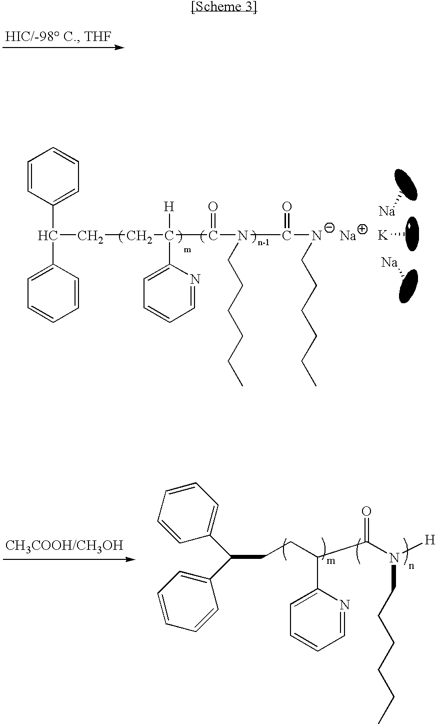

In Scheme 3, a n-hexylisocyanate monomer is added and polymerization is performed for about 20 to 40 minutes to prepare a poly(n-hexylisocyanate) block. A reaction terminator is added to facilitate termination by the terminal active species of the poly(n-hexylisocyanate) block and prevent cyclic trimerization, which is a side reaction. After the reaction has been terminated, the reaction mixture is precipitated in methanol to collect the polymer. For the reaction terminator, methanol, a mixed solution of methanol and hydrochloric acid or a mixed solution of methanol and acetic acid is used. Particularly, a mixed solution of methanol and acetic acid is preferable. In case a methanol mixed solution is used as reaction terminator, the mixing proportion of methanol to hydrochloric acid or acetic acid is preferably in the range of 1:10⁻³ to 10⁻¹ (v/v).

Because the resultant block copolymer of the present invention is amphiphilic, it can be utilized in development of self-assembling film formation devices using its solubility difference for specific blocks. Further, because the poly(2-vinylpyridine) block is capable of coordinating metal particles, it can be utilized in development of nano particles, which are uniformly distributed in a polymer, or functional nano complexes. Also, considering that the isocyanate block has relatively weak thermal stability, the poly(n-hexylisocyanate) block may be removed by heat treatment to obtain a nanoporous material. Moreover, considering the rigid spiral structure of the poly(n-hexylisocyanate) block, a chiral reaction terminator may be used to offer an optical activity to the pyridine block to prepare an optical switch device that can rotate planar polarized light in the UV absorption range. And, it will offer a new block structure model with regard to the research of phase separation of a rod type polyisocyanate and a coil type poly(2-vinylpyridine) block.

### EXAMPLES

Hereinafter, the present invention is described in more detail through examples. However, the following examples are only for the understanding of the present invention, and they should not be construed as limiting the scope of the present invention.

### Example 1

### Homopolymerization of 2-vinylpyridine

2-Vinylpyridine (2VP) was used as monomer. Polymerization was performed at −78° C. and high vacuum (10⁻⁶ torr). Tetrahydrofuran was used as solvent. Polymerization was performed for 10 to 45 minutes. The reaction temperature of −78° C. was maintained by adding dry ice in an acetone thermostatic bath. The temperature of the bath was measured with a low temperature thermometer. Potassium diphenylmethane (K-DPM), an initiator, was prepared from the reaction of a potassium-naphthalene (K-NaPh) ion solution and diphenylmethane. The initiator was promptly isolated in a glass ampoule after being diluted to an adequate concentration by passing through a distribution unit connected to a vacuum line and then kept in a low temperature refrigerator.

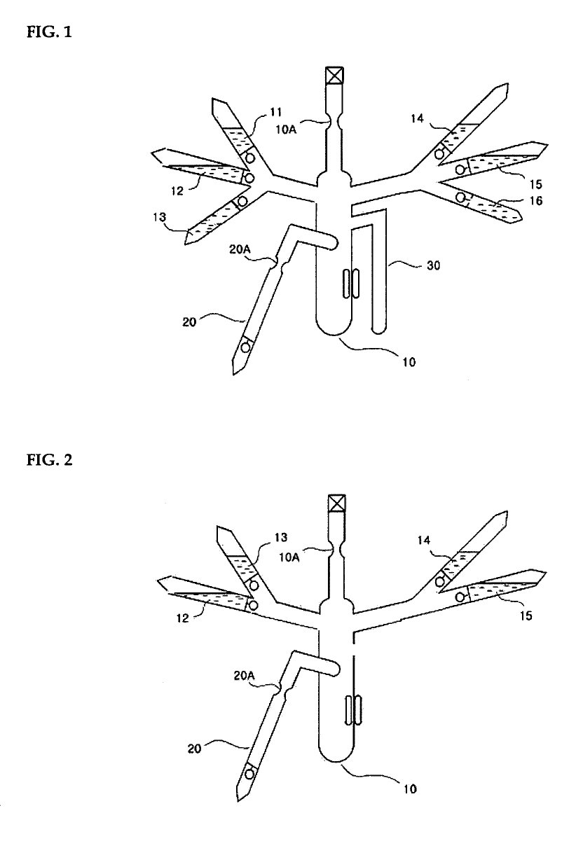

Polymerization was performed using the homopolymer polymerization apparatus illustrated in FIG. 2. The polymerization apparatus comprising glass ampoules containing the purified initiator (K-DPM), the monomer (2-vinylpyridine, 2VP), an additive (sodium tetraphenylborate, NaBPh₄), a reaction terminator (methanol) and a cleansing solution was connected to a vacuum line, so that its inside is maintained at high vacuum and under nitrogen atmosphere, and then sealed off from the vacuum line. After the apparatus had been sealed off from the vacuum line, the ampoule containing the cleansing solution was broken to cleanse the inside of the apparatus. Then, the ampoule containing the initiator was broken. The polymerization apparatus was installed in an acetone thermostatic bath, so that the inside of the apparatus and the reactants reach thermal equilibrium (−78° C.). Then, the monomer was added and polymerization was performed for 10 to 45 minutes. The reaction terminator, methanol, was added to terminate the polymerization. The obtained polymer was precipitated in excess methanol, filtered and then dried under vacuum or lyophilized.

TABLE 1
Homopolymerization of 2-vinylpyridine

| | | | | Number-average | | Molecular weight | |
|---|---|---|---|---|---|---|---|
| | K-DPM | 2VP | Time | molecular weight (Mₙ) | | distribution | Yield |
| No. | (mmol) | (mmol) | (min) | Calculated^{a} | Measured^{b} | (M_{w}/Mₙ) | (%) |
| 1 | 0.077 | 5.58 | 10 | 7,700 | 7,900 | 1.05 | 98 (2)^{c} |
| 2 | 0.076 | 5.80 | 20 | 8,300 | 8,400 | 1.04 | 98 (2)^{c} |
| 3 | 0.085 | 4.03 | 30 | 5,100 | 5,300 | 1.06 | 100 |
| 4 | 0.070 | 4.18 | 5 | 6,500 | 6,800 | 1.06 | 99 |

^{a}Mₙ = ([2VP]/[K-DPM]) × (Molecular weigh of 2VP) + (Molecular weigh of diphenylmehane).
^{b}Measured by gel permeation chromatography at 40° C. using THF and triethylamine solvents.
^{c}Numbers in parentheses are percentages of unreacted 2-vinylpyridne monomer.

As seen in Table 1, when 2-vinylpyridine was polymerized using potassium diphenylmethane, which is a mild initiator, a poly(2-vinylpyridine) homopolymer was obtained with a quantitative yield between 10 to 45 minutes. The molecular weight measured by gel permeation chromatography (GPC) coincided with the calculated value, and a narrow molecular weight distribution (1.06 or below) was obtained.

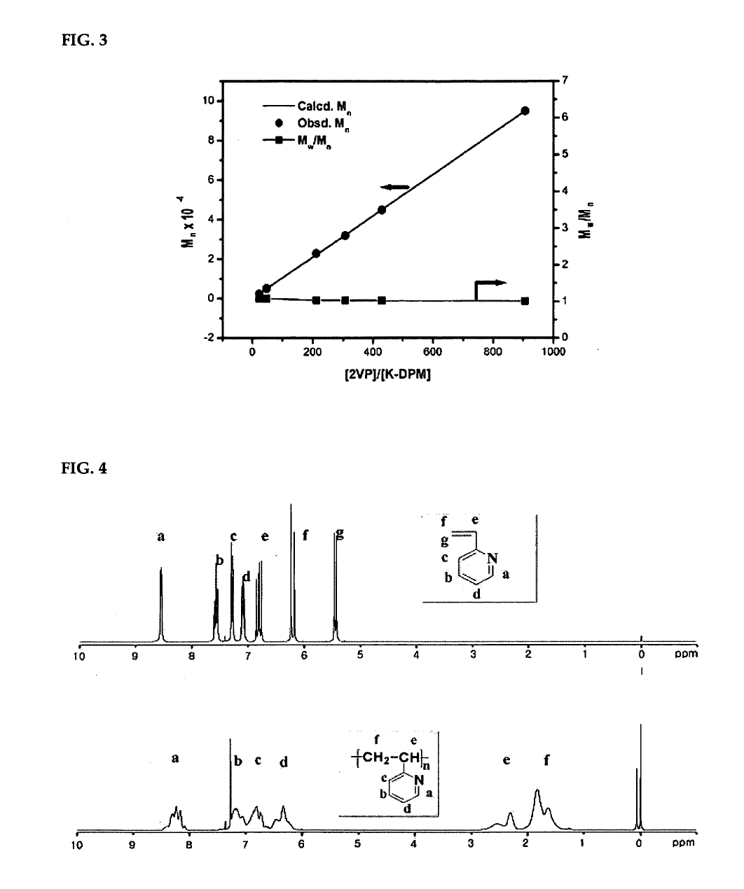

FIG. 3 is a graph showing the molecular weight and the molecular weight distribution of poly(2-vinylpyridine) versus the molar ratio of 2-vinylpyridine and the initiator (K-DPM). As the proportion of the monomer increased, the molecular weight became more linear. This means that 2-vinylpyridine was living polymerized by using potassium diphenylmethane (K-DPM).

FIG. 4 shows the ¹H NMR spectrums of the 2-vinylpyridine monomer and the poly(2-vinylpyridine) homopolymer. As seen in the spectrums, the pyridine ring which normally peaks at about 6 ppm became broader as polymerization proceeded because mobility of the side chain decreased. And, the vinyl peaks of the monomer transferred to the upfield of about 1.35 to 2.89 ppm as polymerization proceeded. This shows that poly(2-vinylpyridine) was successfully synthesized.

### Example 2

### Homopolymerization of n-hexylisocyanate

To find an effective reaction termination condition at the active terminal of the living chain during termination of polyisocyanate polymerization, methanol (a reaction terminator), a mixed solution of methanol and hydrochloric acid (1:0.01 v/v) and a mixed solution of methanol and acetic acid (1:0.01 v/v) was used, respectively.

Polymerization was performed using the homopolymer polymerization apparatus illustrated in FIG. 2. The polymerization apparatus comprising glass ampoules containing an initiator, a monomer, an additive, a reaction terminator and a cleansing solution was connected to a vacuum line, so that its inside is maintained at high vacuum (10⁻⁶ torr) and under nitrogen atmosphere, and then sealed off from the vacuum line. After the inside of the apparatus had been cleansed with the cleansing solution, the apparatus was installed in a thermostatic bath containing methanol of −98° C. which had been frozen by liquid nitrogen, so that thermal equilibrium was reached. Polymerization was performed by adding the initiator, the additive and then n-hexylisocyanate. Polymerization was performed for 20 minutes. Methanol, a mixed solution of methanol and hydrochloric acid and a mixed solution of methanol and acetic acid was used respectively as reaction terminator. The obtained polymer was precipitated in excess methanol, filtered and collected.

TABLE 2
Homopolymerization of n-hexylisocyanate

| | | | | | | | Molecular | | |
|---|---|---|---|---|---|---|---|---|---|
| | | | | | Number-average | | weight | | |
| | K-DPM | NaBPh₄ | HIC | Time | molecular weight (Mₙ) | | distribution | Reaction | Yield |
| No. | (mmol) | (mmol) | (mmol) | (min) | Calculated^{a} | Measured^{b} | (M_{w}/Mₙ) | terminator | (%) |
| 1 | 0.11 | 5.80 | 7.11 | 20 | 8,100 | 8,500 | 1.15 | MeOH | 69 |
| 2 | 0.11 | 5.58 | 6.64 | 20 | 8,600 | 9,400 | 1.13 | MeOH—HCl | 97 |
| 3 | 0.18 | 4.03 | 4.68 | 20 | 7,000 | 7,600 | 1.09 | MeOH—AcOH | 96 |

^{a}Mₙ = ([HIC]/[K-DPM]) × (Molecular weigh of n-hexylisocyanate) + (Molecular weigh of diphenylmehane).
^{b}Measured by gel permeation chromatography at 40 □ using THF and triethylamine solvents.

In the general anion polymerization of poly(n-hexylisocyanate), the amidate anion at the terminal of the polyisocyanate is so weak a nucleophile that the reaction cannot be terminated by methanol. Therefore, delay of reaction termination, disuniformity of reaction rate, etc. have caused such side reaction as trimerization by the terminal amidate anion, which reduces the polymerization yield. To facilitate the reaction termination, it is preferable to use a mixed solution of and methanol an acid as reaction terminator.

Table 2 shows the result of polymerizing poly(n-hexylisocyanate) using several reaction terminators. When methanol, a common reaction terminator, was used, the polymerization yield was only 69% and the molecular weight distribution was relatively broad. This means that reaction of methanol with the relatively stable amidate ion was proceeded neither quickly nor completely. When a mixed solution of hydrochloric acid or acetic acid and methanol was used to terminate the reaction, a quantitative yield and a relatively narrow molecular weight distribution were obtained. Of the two reaction terminators, the mixed solution of methanol and hydrochloric acid may cause quaternization of the pyridine ring, if used in block copolymerization of 2-vinylpyridine and n-hexylisocyanate, to give a non-soluble polymer. Thus, the mixed solution of methanol and acetic acid, which is milder, is the most suitable reaction terminator in polymerization of poly(n-hexylisocyanate).

### Example 3

### Block Copolymerization of 2-vinylpyridine and n-hexylisocyanate

2-Vinylpyridine (2VP) was used as the first monomer. Polymerization of 2-vinylpyridine was performed at −78° C. and high vacuum (10⁻⁶ torr) using tetrahydrofuran as solvent. Polymerization was performed for 30 minutes. The reaction temperature of −78° C. was maintained by adding dry ice to an acetone thermostatic bath. The temperature of the thermostatic bath was measured using a low temperature thermometer.

Polymerization was performed using the block copolymerization apparatus illustrated in FIG. 1. The polymerization apparatus comprising glass ampoules containing a purified initiator (K-DPM), monomers (2-vinylpyridine and n-hexylisocyanate), an additive (sodium tetraphenylborate, NaBPh₄), a reaction terminator (mixed solution of methanol and acetic acid) and a cleansing solution was connected to a vacuum line, so that its inside is maintained at high vacuum and under nitrogen atmosphere, and then sealed off from the vacuum line. After the apparatus had been sealed off from the vacuum line, the ampoule containing the cleansing solution was broken to cleanse the inside of the apparatus. Then, the ampoule containing the initiator was broken. The polymerization apparatus was installed in an acetone thermostatic bath, so that the inside of the apparatus and the reactants reach thermal equilibrium (−78° C.). Then, 2-vinylpyridine was added and polymerization was performed for 30 minutes. Part of the poly(2-vinylpyridine) homopolymer solution was transferred to a homopolymer collection tube 30. The sodium tetraphenylborate additive was added to replace the potassium counter cation with a sodium ion. The reaction apparatus was immersed in a thermostatic bath cooled to −98° C. by adding liquid nitrogen to methanol. After the temperature reached equilibrium, n-hexylisocyanate, the second monomer, was added and reaction was performed for 20 minutes. The reaction terminator, mixed solution of methanol and acetic acid, was added to terminate the polymerization. The obtained polymer was precipitated in excess methanol, filtered and then dried at vacuum or lyophilized.

TABLE 3
Block copolymerization of 2-vinylpyridine and n-hexylisocyanate

| | | | | | | Time | | | | |
|---|---|---|---|---|---|---|---|---|---|---|
| | | | | | | (min)/ | Number-average | | Polydiversity | |
| | | K-DPM | 2VP | [NaBPh₄]/ | HIC | temperature | molecular weight (Mₙ) | | index | Yield |
| No. | | (mmol) | (mmol) | [K-DPM] | (mmol) | (° C.) | Calculated^{a} | Measured^{b} | (M_{w}/Mₙ) | (%) |
| 1 | H^{c} | 0.076 | 2.59 | — | — | 30/−78 | 3,800 | 4,400 | 1.09 | 100 |
| | B^{d} | 0.066 | 2.49 | 0 | 5.07 | 20/−98 | 13,800 | 9,100 | 1.22 | 70 |
| 2 | H^{c} | 0.120 | 4.58 | — | — | 30/−78 | 4,100 | 4,100 | 1.06 | 100 |
| | B^{d} | 0.090 | 3.53 | 5.6 | 5.43 | 20/−98 | 11,900 | 15,000 | 1.16 | 98 |
| 3 | H^{c} | 0.089 | 3.41 | — | — | 30/−78 | 4,200 | 4,300 | 1.05 | 100 |
| | B^{d} | 0.079 | 3.40 | 6.6 | 5.49 | 20/−98 | 13,500 | 15,000 | 1.11 | 98 |
| 4 | H^{c} | 0.120 | 5.83 | — | — | 30/−78 | 5,100 | 5,500 | 1.05 | 100 |
| | B^{d} | 0.100 | 4.68 | 9.6 | 5.67 | 20/−98 | 24,300 | 29,000 | 1.11 | 97 |
| 5 | H^{c} | 0.120 | 5.74 | — | — | 30/−78 | 5,100 | 5,500 | 1.05 | 100 |
| | B^{d} | 0.100 | 5.64 | 15.0 | 15.0 | 20/−98 | 23,600 | 20,300 | 1.14 | 78 |

^{a}Mₙ = ([2VP]/[K-DPM]) × (Molecular weigh of 2-vinylpyridine) + ([HIC]/[K-DPM]) × (Molecular weigh of n-hexylisocyanate) + (Molecular weigh of diphenylmehane).
^{b}Measured by gel permeation chromatography at 40° C. using THF and triethylamine solvents.
^{c}Homopolymerization of 2VP.
^{d}Bock copolymerization of 2VP homopolymer and HIC.

Table 3 shows the result of block copolymerization of 2-vinylpyridine and n-hexylisocyanate at different concentration of the sodium tetraphenylborate additive. Poly(n-hexylisocyanate) had a quantitative yield and a narrow molecular weight distribution when a sodium ion was used as counter cation. Especially, when sodium tetraphenylborate, which acts as common ion salt, was used, polymerization of n-hexylisocyanate became more quantitative as the potassium ion counter cation was replaced with a sodium ion. Also, sodium tetraphenylborate increased the concentration of the sodium counter cation, so that the amidate anion at the terminal of the living polymer chain contact with the sodium ion. Consequently, anion living polymerization became possible. The polymerization is preferable to perform for 20 to 40 minutes.

As seen in Table 3, the 2-vinylpyridine block polymerized using potassium diphenylmethane as initiator showed a quantitative yield, a narrow molecular weight distribution and a controlled molecular weight. The potassium counter cation was replaced with a sodium ion using sodium tetraphenylborate of different concentration. Then, the reaction temperature was set at −98° C. and n-hexylisocyanate was added. When no sodium tetraphenylborate was used, the yield of the isocyanate block was low and cyclic trimers, product of a side reaction, was observed. However, when sodium tetraphenylborate was used, a block copolymer having a quantitative yield and a narrow molecular weight distribution was obtained.

Consequently, an amphiphilic coil-rod type block copolymer having a controlled fine structure was obtained. When the concentration of sodium tetraphenylborate was increased to 15 times that of the initiator, the yield of the hexylisocyanate block decreased. According to the NMR analysis, n-hexylisocyanate was remaining unreacted. This means that the polymer could not propagate fully because of excess sodium ion.

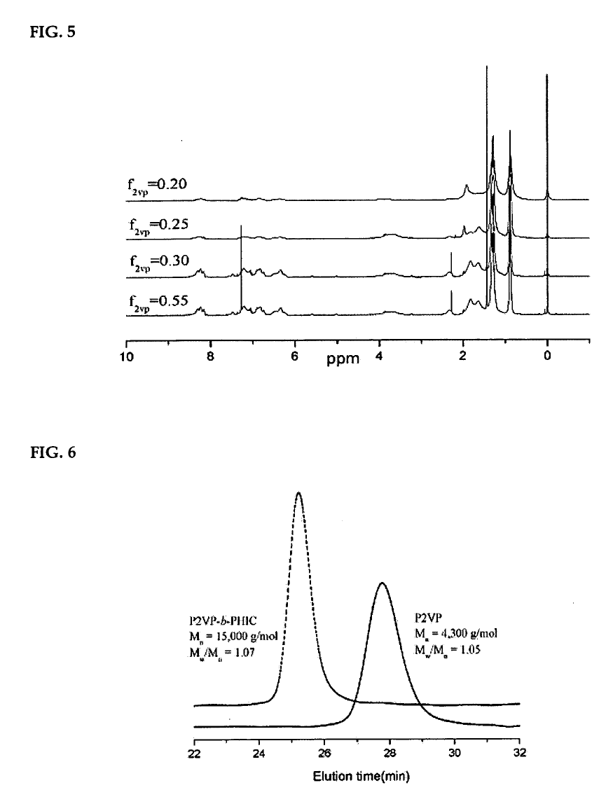

FIG. 5 shows the ¹H NMR spectrums of the poly(2-vinylpyridine)-b-poly(n-hexylisocyanate) block copolymer synthesized at different poly(2-vinylpyridine) block ratio (f₂ᵥₚ). As seen in the spectrums, the size of each peak varied a lot depending on the ratio. When the composition of each block was calculated based on the spectrums, it was almost identical to the proportion of the reaction. ¹H NMR and FT-IR analysis results of the block copolymer is as follows.

¹H NMR (CDCl₃, 300 MHz), δ (ppm): 0.9 (3H, CH₃), 1.00-2.10 (10H, (CH₂)₄ of n-hexylisocyanate, CH₂ of 2-vinylpyridine main chain), 2.10-2.89 (1H, CH of 2-vinylpyridine), 3.36-4.14 (2H, —CH₂—N of n-hexylisocyanate), 6.11-7.35 (3H, CH of 2-vinylpyridine ring), 8.02-8.55 (1H, CH of 2-vinylpyridine ring); FT-IR (KBr, cm⁻¹): 3432 (NH), 3076 (CH of 2-vinylpyridine ring), 2935 (aliphatic, CH₂—CH of main chain 2-vinylpyridine block), 1698 (C═O), 1590 (C═C), 1474 (C═N).

FIG. 6 shows the gel permeation chromatography result of the poly(2-vinylpyridine) homopolymer and the poly(2-vinylpyridine)-b-poly(n-hexylisocyanate) block copolymer. Both the 2-vinylpyridine homopolymer and the block copolymer showed a single peak. A successful transition from the homopolymer to the block copolymer was confirmed by identifying the molecular weight.

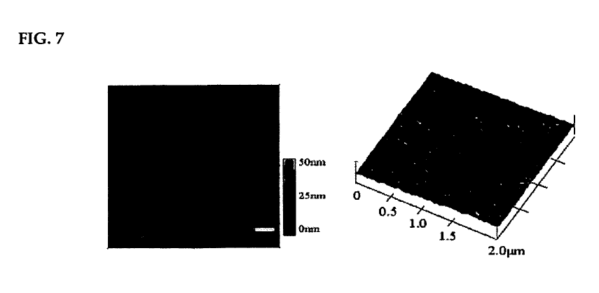

FIG. 7 shows the surface of the poly(2-vinylpyridine)-b-poly(n-hexylisocyanate) block copolymer analyzed by means of AFM. The AFM analysis was performed after dissolving a block copolymer sample (molecular weight=158,300 mg/mol, concentration=5 mg/mL, composition of n-hexylisocyanate=81%) in chloroform, casting it on a substrate and annealing at about 110° C. for 12 hours. As seen in FIG. 7, the block copolymer showed phase separation behavior and liquid crystalintiy due to the rod type isocyanate block. Hence, the block copolymer is expected to be utilized as self-assembling nanoparticles or a nanocomposite with inorganic nanoparticles.

The block copolymer of the present invention is an amphiphilic coil-rod block copolymer comprising a coil type poly(2-vinylpyridine) block having a hydrophilic group and a rod type poly(n-hexylisocyanate) block having a lipophilic group. The coil type poly(2-vinylpyridine) block, the first block of the block copolymer of the present invention, is a material that is drawing attention for use in complexes with metals, conductive materials, optical device, etc. due to its electric characteristics. The poly(n-hexylisocynate) block, or the second block, is also a material that is drawing attention because the main polymer chain is rigid due to amide bonding and it is known to have a spiral structure as in biomolecules such as polypeptides. Thus, the block copolymer of the present invention, which comprises the two blocks and the molecular weight and composition of each block of which is controllable, is expected to be useful as a new high-tech material.

While the present invention has been described in detail with reference to the preferred embodiments, those skilled in the art will appreciate that various modifications and substitutions can be made thereto without departing from the spirit and scope of the present invention as set forth in the appended claims.

1. An amphiphilic coil-rod block copolymer comprising a coil type poly(2-vinylpyridine) block having a hydrophilic group and a rod type poly(n-hexylisocyanate) block having a lipophilic group.

2. A method of polymerizing an amphiphilic coil-rod block copolymer comprising:
synthesizing a poly(2-vinylpyridine) block by living polymerization using potassium diphenylmethane (KCHPh₂) as initiator;
replacing the potassium counter cation of the poly(2-vinylpyridine) block with a sodium ion by adding sodium tetraphenylborate (NaBPh₄); and
adding n-hexylisocyanate and performing polymerization to prepare a poly(n-hexylisocyanate) block.

3. The method of claim 2, wherein the poly(2-vinylpyridine) block has a molecular weight distribution (M_{w}/Mₙ) ranging from 1.00 to 1.09.

4. The method of claim 2, wherein a mixed solution of methanol and acetic acid is used as reaction terminator.
